(19) United States
(12) Patent Application Publication
(10) Pub. No.: US 2011/0150493 A1
(43) Pub. Date: Jun. 23, 2011

(54) OPTICAL MODULE

(76) Inventors: Mariko NAKASO, Osaka (JP); Tomoaki Ieda, Osaka (JP)

(21) Appl. No.: 12/955,305

(22) Filed: Nov. 29, 2010

(30) Foreign Application Priority Data
Dec. 18, 2009 (JP) 2009-287928

(51) Int. Cl. H04B 10/00

(52) U.S. Cl. 398/130

(57) ABSTRACT

A light module 100 performs short-range wireless communication with another optical module 200, and includes an optical transmitter 120 for emitting a transmission optical beam, and an optical receiver 130 for receiving a reception optical beam. The optical transmitter 120 includes a light source 121 for emitting an optical signal based on information to be transmitted, and a lens 122 for the light source 121, for focusing the optical signal emitted by the light source so that the focused optical signal is emitted. The transmission optical beam includes a main beam having a center of intensity distribution at a substantially center position 128 of the lens 122 for the light source 121, and a sub-beam having a center of intensity distribution on the outside 129 of a predetermined region from the center of intensity distribution of the main beam.

### BACKGROUND OF THE INVENTION

1. Field of the Invention

The present invention relates to an optical module for emitting an optical beam to space to transmit/receive information to/from a terminal, and more particularly, to technology for performing high-speed communication among mobile devices.

2. Description of the Background Art

In recent mobile devices, such as mobile phones, the number of models that allow capturing of high-definition static images and/or moving images, is increasing. There are increasing uses for mobile devices, such as where a user transmits to another mobile device the static images and/or moving images, which are captured by such a mobile device, to share with another user, or where a user transfers to a PC the static images and/or moving images for backup. Moreover, it is often the case that the user transfers data, such as moving image content and/or music content, from his/her PC or a sales site to the mobile device so that the user can playback the transferred data while he/she is traveling or away from home.

Examples of methods for data transfer between mobile devices or between a mobile device and a PC, include: a method of directly connecting them to each other by a cable; a method of interchanging memory cards; or a method using short-range wireless communication. Particularly, the method using short-range wireless communication, because of its simplicity, is expected to be most frequently utilized.

For the short-range wireless communication among the mobile devices, an infrared communication module, which is represented by, for example, IrDA (Infrared Data Association or infrared communication standard defined by the association), is often used. The short-range wireless communication is widely utilized in various electronic devices such as mobile phones, PCs, and printers.

However, even though conventional short-range wireless communication using the infrared communication module is frequently utilized to exchange phone numbers or addresses easily, the communication speed is too slow to be suitably utilized for transferring a large amount of data, such as high-definition static images and/or moving images.

Consequently, an increase in the speed of the short-range wireless communication using the infrared communication module is desired in order to easily transfer the large amount of data.

Meanwhile, the optical module, like the infrared communication module described above, generally includes a light-emitting diode for emitting optical beam, a photodiode for receiving optical beam, and further includes a transmission lens for focusing within a desired transmission region an optical beam generated by the light-emitting diode so that the focused optical beam is emitted from the transmission lens which is emitted to space and diffused, a reception lens for focusing transmission optical beam, so that the focuses optical beam on the photodiode, and the like.

Moreover, as compared to wireless communication using a radio wave, wireless communication using the optical module has advantages such as low cost, low power operation, and size reduction of a device. In order to increase the communication speed, however, signal processing needs to be performed, while maintaining a sufficient signal-to-noise (SN) ratio at a receiver. Therefore, high irradiance needs to be obtained, which requires that a transmission optical beam is narrowed and focused by using the lens for performing the communication.

For example, in Giga-IR, a standard for the next generation of high-speed infrared communication whose specification is being developed by IrDA, in order to perform communication at 1 Gbps in distances of over 1 cm, studies are underway on a transmission beam to have an angular range of about 5° to 10°.

In addition, since the wireless communication using the optical module described above is bidirectional communication, each of both optical modules includes a transmitter and a receiver, and the transmitter and the receiver are usually disposed side by side. Therefore, when the transmission optical beam is narrowed and collected, no problem occurs if a receiver of one optical module is positioned in front of a transmitter of another optical module, and a transmitter of the one optical module is positioned in front of a receiver of the other optical module. On the contrary, if the communication is performed in a state where the transmitter of the one optical module is positioned in front of the transmitter of the other optical module, and the receiver of the one optical module is positioned in front of the receiver of the other optical module, a problem occurs that the communication cannot be performed in a short distance less than or equal to about 1 cm.

Japanese Laid-Open Patent Publication No. 2005-64993 (Patent Literature 1) discloses an optical wireless system which solves the problem described above. In the optical wireless system disclosed in Patent Literature 1, a master device scans, two-dimensionally, transmission optical beam having a narrow orientation angle. A slave device uses a receiver element array or a micro electro-mechanical system (MEMS) to detect a direction of the transmission optical beam, based on the position of reception optical beam on the photo detecting array, and returns the transmission optical beam to the master device in the detected direction. Thus, the transmission direction can be detected. Accordingly, the communication can be performed even with an optical beam having a narrow orientation angle.

### SUMMARY OF THE INVENTION

However, in the optical wireless system disclosed in Patent Literature 1 described above, the photodetecting array or the MEMS causes an increase in the scale of the optical wireless system. In addition, an optical axis needs to be adjusted before the communication is performed between mobile devices, which requires excessive time.

Therefore, an objective of the present invention is to provide an optical module and an optical wireless system that are small scale and require no optical axis adjustment, and in which, when the communication is performed with a transmission optical beam being narrowed and collected by using a lens for achieving high-speed communication, or the like, even if optical modules become close to each other, high-speed optical wireless communication can be performed regardless of whether transmitters (receivers) face each other between the respective communication devices.

The present invention is directed to an optical module, and an optical wireless system. In order to achieve the objective described above, the optical module of the present invention is an optical module for performing short-range wireless communication with an other optical module, and includes an optical transmitter, and an optical receiver. The optical transmitter emits a transmission optical beam to the other optical module. The optical receiver receives a reception optical beam from the other optical module. The optical transmitter includes a light source, and a lens for the light source. The light source emits an optical signal based on information to be transmitted. The lens for the light source focuses the optical signal emitted by the light source so that the condensed optical signal is emitted.

The transmission optical beam includes a main beam, and a sub-beam. The main beam has a center of the intensity distribution at a substantially center position of the lens for the light source. The sub-beam has a center of the intensity distribution outside of a predetermined region from the center of the intensity distribution of the main beam.

Preferably, the light source emits optical signals from a top surface and side surfaces thereof, a principal component of the main beam is the optical signal emitted from the top surface of the light source, and focused by the lens for the light source, and a principal component of the sub-beam is the light source emitted from the side surfaces of the light source, and focused by the lens for the light source.

Preferably, the lens for the light source includes a main focusing surface and a sub focusing surface. On the main focusing surface, a center portion of the optical signal emitted by the light source is focused so that the main beam is emitted. On a sub focusing surface, portions, except for the center portion, of the optical signal emitted by the light source are focused so that the sub-beam is emitted.

Preferably, an irradiation angle θ of the sub-beam satisfies the following conditions: tan⁻¹ {(D−Rt−Rr)/Le}≦θ≦tan⁻¹(D/L), where D is a distance between an optical transmitter included in the other optical module and a optical receiver included in the other optical module, in a direction parallel to a mounting substrate of the other optical module on which the optical transmitter and the optical receiver are mounted, Rt is a radius of the lens for the light source, Rr is a radius of a lens for a photodetector, included in the optical receiver provided in the other optical module, L is a distance, of a direction component perpendicular to the mounting substrate of the other optical module, between an end of the lens for the light source and an end of the lens for the light source included in the optical transmitter provided in the other optical module in their closest approach where normal communication should be performed, and Le is a distance, of the direction component perpendicular to the mounting substrate of the other optical module, between the light source and a light source included in the optical transmitter provided in the other optical module in their closest approach where the normal communication should be performed.

Preferably, the optical module further includes a mounting substrate, a first reflector, and a second reflector. The light source and the photodetector are mounted on the mounting substrate, the first reflector, facing the mounting substrate between the light source and the photodetector, reflects a portion of the beam emitted from the lens for the light source, and the second reflector, disposed between the light source and the photodetector on the mounting substrate, further reflects the beam having been reflected by the first reflector to reflect the beam reflected by the first reflector as a sub-beam.

Preferably, the optical module further includes a mounting substrate, a first reflector, and a second reflector. The light source and the photodetector are mounted on the mounting substrate, the first reflector, facing the mounting substrate, reflects the sub-beam, and the second reflector, disposed between the light source and the photodetector on the mounting substrate, further reflects the sub-beam reflected by the first reflector.

In order to achieve the objective described above, the optical wireless system of the present invention performs short-range wireless communication between a first optical module and a second optical module.

The first optical module includes a first optical transmitter and a first optical receiver. The first optical transmitter emits a first transmission optical beam to the second optical module. The first optical receiver receives a reception optical beam from the second optical module. The first optical transmitter includes a first light source and a first lens for the first light source. The first light source emits an optical signal based on information to be transmitted. The first lens for the first light source focuses the optical signal emitted by the first light source so that the condensed signal is emitted.

The first transmission optical beam includes a first main beam and a first sub-beam. The first main beam has a center of the intensity distribution at a substantially center position of the first lens for the first light source. The first sub-beam has intensity distributions outside a predetermined region from the center of the intensity distribution of the first main beam.

The second optical module includes a second optical transmitter and a second optical receiver. The second optical transmitter emits a second transmission optical beam to the first optical module. The second optical receiver receives a reception optical beam from the first optical module. The second optical transmitter includes a second light source and a second lens for the second light source. The second light source emits an optical signal based on information to be transmitted. The second lens for the second light source focuses the optical signal emitted by the second light source so that the condensed optical signal is emitted.

The second transmission optical beam includes a second main beam and a second sub-beam. The second main beam has a center of the intensity distribution at a substantially center position of the second lens for the second light source. The second sub-beam has a center of the intensity distribution outside a predetermined region from the center of the intensity distribution of the second main beam.

As described above, in the present invention, a sub-beam, which has the center of the intensity distribution outside the effective region of a main beam, can be emitted together with the main beam.

According to this configuration, the receivable region can be extended broader than the conventional under a difficult situation, for example, where the optical modules become close to each other and thereby the respective optical transmitters face each other and the respective optical receivers face each other. Excellent communication can be performed, particularly, in a short distance. Thus, the present invention is highly useful.

Therefore, according to the present invention, when the communication is performed with the transmission optical beam being narrowed and collected by using the lens even if the optical modules become close to each other, high-speed optical wireless communication can be performed regardless of whether the transmitters (receivers) face each other between the respective communication devices. Moreover, the optical module of the present invention is small scale and requires no optical axis adjustment.

### BRIEF DESCRIPTION OF THE DRAWINGS

FIG. 1 is a diagram showing a situation where short-distance communication is performed between mobile devices using an optical wireless system of a first embodiment.

FIG. 2 is a diagram showing an outline of an optical wireless system 10 of the first embodiment.

FIG. 3A is a diagram showing an outline of a cross-section of a conventional optical transmitter 920.

FIG. 3B is a diagram showing an outline of a cross-section of a optical transmitter 120 of the first embodiment.

FIG. 4 is a diagram showing an outline of the optical wireless system 10 in a state where an optical module 100 and an optical module 200 are spaced from each other by a certain distance.

FIG. 5 is a diagram showing relation between an emission angle and emission intensity of the optical module 100 of the first embodiment.

FIG. 6A and FIG. 6B are diagrams each showing relation between the distance between optical modules, receiving irradiance, and minimum irradiance, obtained by simulation in the optical wireless system 10 of the first embodiment.

FIG. 7 is a diagram showing an outline of the optical wireless system 10 when the short-distance communication is performed.

FIG. 8 is a diagram showing an outline of the optical wireless system 10 of the second embodiment.

### DESCRIPTION OF THE PREFERRED EMBODIMENTS

### Embodiment 1

### Configuration

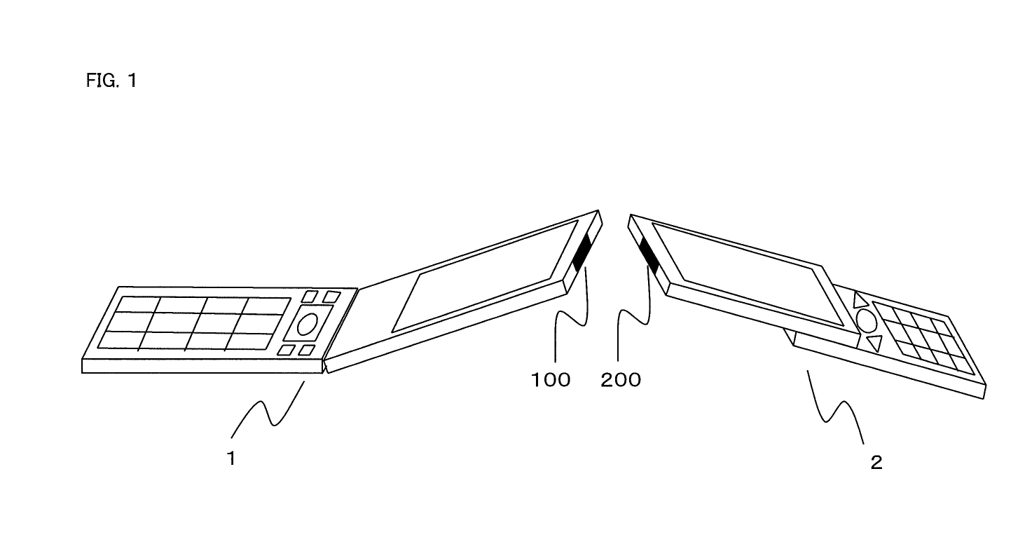

FIG. 1 is a diagram showing a situation where short-distance communication is performed between mobile devices using an optical wireless system of a first embodiment. Mobile devices 1 and 2 are, for example, mobile phones, and include an optical module 100 and an optical module 200, respectively, as shown in FIG. 1. The optical module 100 and the optical module 200 face each other for performing short-range wireless communication.

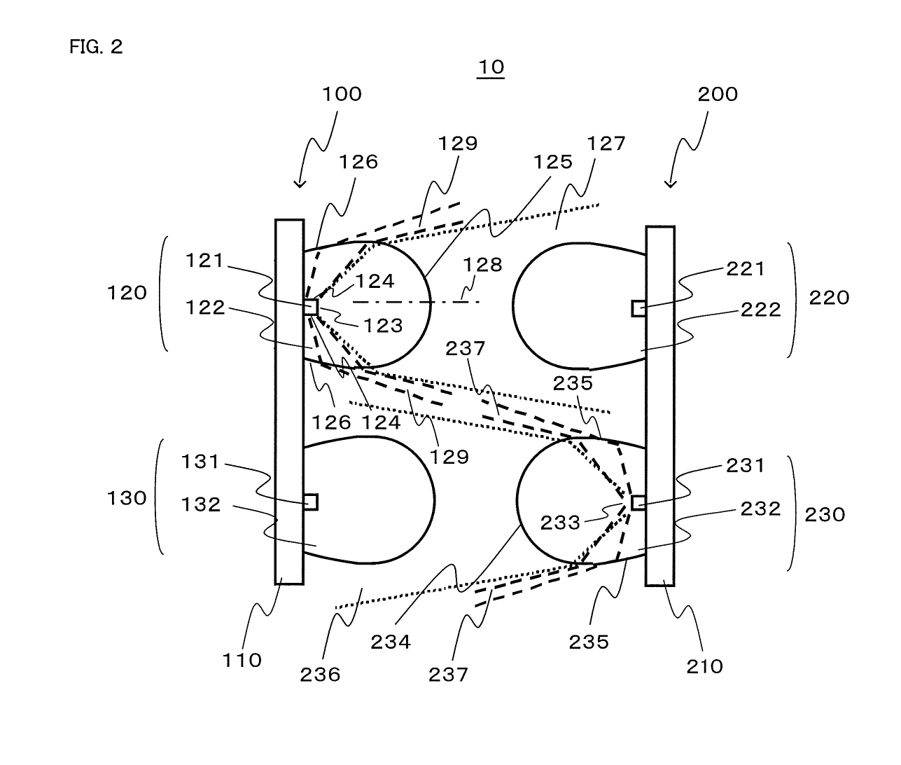

FIG. 2 is a diagram showing an outline of an optical wireless system 10 of the first embodiment.

In FIG. 2, the optical module 100 and the optical module 200 are a unit for the short-range wireless communication in which each module emits an optical beam to space to perform data communication therebetween.

In FIG. 2, the optical module 100 and the optical module 200 are close to each other with a distance of about 4 mm therebetween; and their optical transmitters face each other and their optical receivers face each other.

The optical module 100 and the optical module 200 have the same substantial configurations and operations.

Therefore, a description in detail is given below mainly of a situation in which data is transmitted from the optical module 100 to the optical module 200.

The optical module 100 includes a mounting substrate 110, an optical transmitter 120, and an optical receiver 130.

The optical module 200 includes a mounting substrate 210, an optical transmitter 220, and an optical receiver 230.

The mounting substrate 110 is a flat plate formed of an insulator, such as glass epoxy, and has the optical transmitter 120 and the optical receiver 130 mounted thereon so as to be disposed side by side, being spaced from each other by a predetermined distance. The predetermined distance is about 5 mm.

The optical transmitter 120 includes a light source 121 and a resin lens 122.

The light source 121 is a semiconductor device, such as a light emitting diode (LED) or a vertical cavity surface emitting laser (VCSEL), and emits an optical signal based on information to be transmitted mainly from a top surface 123 (a surface facing the optical module 200: a right side surface of the light source 121 in FIG. 2). Particularly, in a case where the light source 121 is an LED, the light source 121 emits not only an optical beam from the top surface 123, but also optical signals based on the information to be transmitted, from both the top surface 123 and the side surfaces 124, because the light source 121 has distribution of optical emission on side surfaces 124 thereof (surfaces between the mounting substrate 110 and the top surface, which are a total of four surfaces of top, bottom, forward, and back in FIG. 2). In the short-range wireless communication using a conventional optical module, the optical signals emitted from the side surfaces 124 do not contribute to the communication. In the first embodiment, however, these optical signals can be used for the communication.

The resin lens 122 is a lens for the light source 121, which is formed of a resin highly transparent to a wavelength of a specification optical source, such as an epoxy resin. The resin lens 122 has a diameter of about 2 mm to 5 mm. The resin lens 122 includes a first focusing surface 125 for the light source 121, and a second focusing surface 126 for the light source 121.

Among the optical signals emitted from the light source 121, an optical signal, which is emitted mainly from the top surface or from the center portion of the top surface, is focused within an optical irradiation region 127 (a region within fine-dotted lines in FIG. 2) by the first focusing surface 125, and the focused optical signal is emitted as a main beam that has a predetermined effective region (the optical irradiation region 127) where the center of optical intensity distribution is at a substantially center position 128 (a dash-dotted line in FIG. 2) of the resin lens 122.

The predetermined effective region is a region to which the main beam, at a level greater than an effective level, is actually outputted. The predetermined effective region may be, for example, a region determined at the time of designing a device, or a region determined based on a standard to be complied with. In the present embodiment, the predetermined effective region indicates a region, determined according to a standard relating to the short-range wireless communication such as IrDA, such that a beam output at a level equal to or greater than specified needs to be maintained.

On the other hand, among the optical signals emitted from the light source 121, optical signals, which are emitted mainly from the side surfaces, or from an area near the top surface, are focused within an optical irradiation region 129 (a region within sparsely-dashed lines in FIG. 2) by the second focusing surface 126, and the focused optical signals are emitted as sub-beams each having the center of the optical intensity distribution outside a predetermined region from the center of the optical intensity distribution of the main beam.

The predetermined region from the center of the optical intensity distribution of the main beam is a region which surrounds the center of the optical intensity distribution, and to which the main beam is outputted at an effective level, even if the effective level is equivalent to or somewhat lower than that in the center of the optical intensity distribution. The predetermined region from the center of the optical intensity distribution of the main beam may coincide with the predetermined effective region described above, for example. The outside of the predetermined region is a region that does not belong to the predetermined region, that is, a region near the predetermined region. In the present embodiment, the outside of the predetermined region from the center of the optical intensity distribution of the main beam is outside the predetermined effective region described above, and indicates outside of the region in which the beam output at the level equal to or greater than specified needs to be maintained, determined according to a standard relating to the short-range wireless communication such as IrDA.

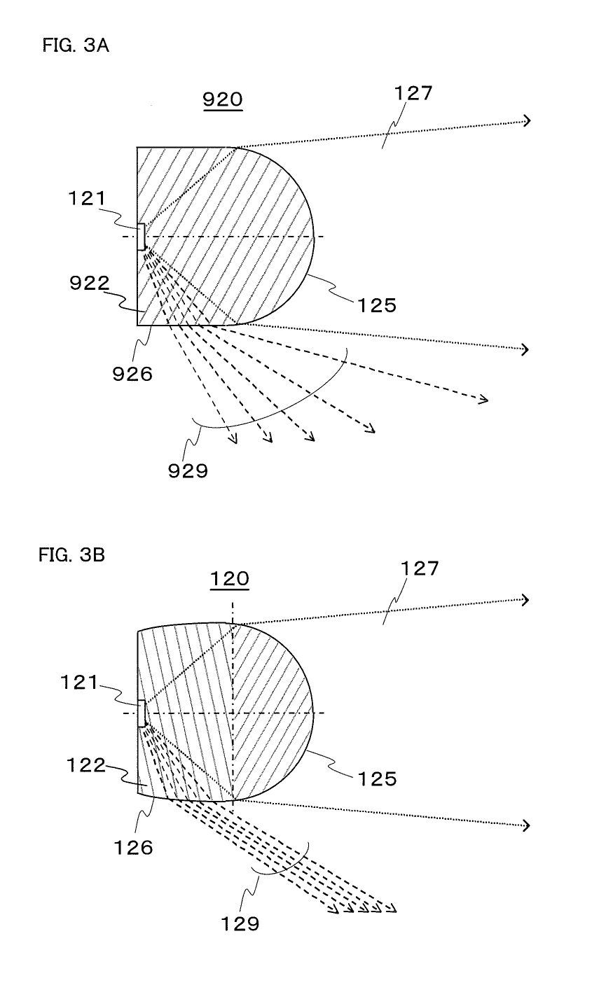

FIG. 3A is a diagram showing an outline of a cross-section of a conventional optical transmitter 920.

FIG. 3B is a diagram showing an outline of a cross-section of the optical transmitter 120 of the first embodiment. The same reference numerals are given to the components of the optical transmitter 920 that are similar to those in the optical transmitter 120. Additionally, the optical transmitter 920 includes a resin lens 922, instead of the resin lens 122 of the optical transmitter 120. The resin lens 922 does not have the second focusing surface 126.

As shown in FIG. 3A, in the conventional optical transmitter 920, among the optical signals emitted from the light source 121, the optical signal, which is emitted from the top surface 123 of the light source 121 or from the center portion of the top surface 123, is emitted from the first focusing surface 125 to the optical irradiation region 127 which is in front of the module 100. However, among the optical signals emitted from the light source 121, the optical signals, which are emitted from the side surfaces 124 or from the area near the top surface 123, are each outputted as diffusion optical 929 because a lens edge 926 does not have a condensation function.

On the other hand, as shown in FIG. 3B, in the optical transmitter 120, among the optical signals emitted from the light source 121, the optical signal, which is emitted from the top surface 123 of the light source 121 or from the center portion of the top surface 123, is emitted from the first focusing surface 125, as the main beam, to the optical irradiation region 127 which is in front of the module 100, in a similar manner to the conventional optical transmitter 920. However, among the optical signals emitted from the light source 121, the optical signals, which are emitted from the side surfaces 124 or from the area near the top surface 123, are emitted from the second focusing surface 126, as the sub-beams, to the optical irradiation region 129 near the main beam because the second focusing surface 126 is formed by curving the lens edge convexly.

The optical receiver 130 has a similar configuration to that of the optical receiver 230 of the optical module 200, and includes a photodetector 131 and a resin lens 132.

The mounting substrate 210 has a similar configuration to that of the mounting substrate 110, and has the optical transmitter 220 and the optical receiver 230 mounted thereon so as to be disposed side by side, being spaced from each other by a predetermined distance.

The optical transmitter 220 has a similar configuration to that of the optical transmitter 120, and includes a light source 221 and a resin lens 222.

The transmission optical beam emitted from the optical transmitter 120 of the optical module 100 needs to be received by the optical receiver 230 of the optical module 200.

The optical receiver 230 includes a photodetector 231 and a resin lens 232.

The photodetector 231 receives the optical signal on a top surface 233 thereof (a surface facing the optical module 100: a left side surface of the photodetector 231 in FIG. 2).

The resin lens 232 is formed of a resin highly transparent to the wavelength of the specification optical source, such as an epoxy resin. The resin lens 232 has a diameter of about 2 mm to 5 mm. The resin lens 232 includes a first focusing surface 234 for the photodetector 231, and a second focusing surface 235 for the photodetector 231.

In a state where the optical module 100 and the optical module 200 are close to each other and thereby the respective optical transmitters face each other and the respective optical receivers face each other as shown in FIG. 2, sub-beams, focused within the optical irradiation region 129 by the second focusing surface 126, are effective, among the transmission optical beams transmitted from the optical module 100.

In FIG. 2, the sub-beams emitted by the optical module 100 falls into the condensation region 237 caused by the second focusing surface 235, and thus the sub-beams are focused by the second focusing surface 235 of the resin lens 232 so that the focused sub-beams are irradiated on the photodetector 231, and the optical signal is received.

On the other hand, among the transmission optical beams transmitted by the optical module 100, the main beam focused within the optical irradiation region 127 by the first focusing surface 125 is effective in a state where the optical receiver 230 is present in front of the optical transmitter 120, or where the optical module 100 is not so close to the optical module 200 although the respective optical transmitters face each other and the respective optical receivers face each other.

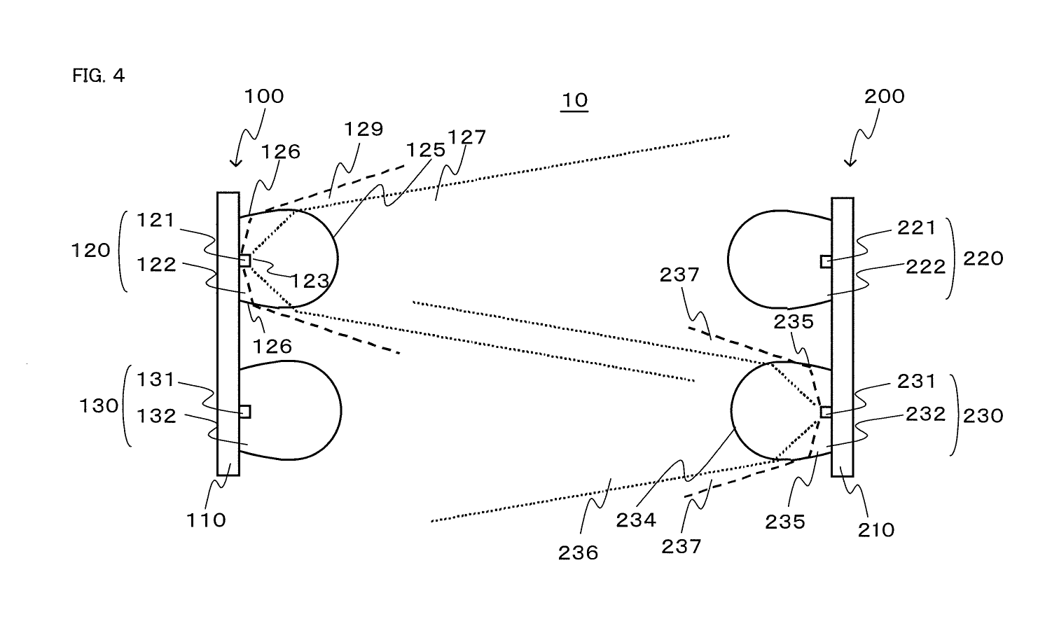

FIG. 4 is a diagram showing an outline of an optical wireless system 10 in a state where the optical module 100 and the optical module 200 are spaced from each other by a certain distance.

In FIG. 4, the optical module 100 and the optical module 200 are spaced from each other by a distance of about 12 mm to 15 mm, and the respective optical transmitters face each other and respective optical receivers face each other.

When the optical module 100 and the optical module 200 are spaced from each other by a certain distance as shown in FIG. 4, the communication is performed by using the main beam focused within the optical irradiation region 127 by the first focusing surface 125, among the transmission optical beams transmitted from the optical module 100, regardless of whether the respective optical transmitters face each other and the respective optical receivers face each other, or whether the optical transmitter faces the corresponding optical receiver.

In FIG. 4, the main beam emitted by the optical module 100 falls into the condensation region 236 caused by the first focusing surface 234. Thus the main beam is focused by the first focusing surface 234 of the resin lens 232 and the focused main beam is irradiated on the photodetector 231, and thereby the optical signal is received.

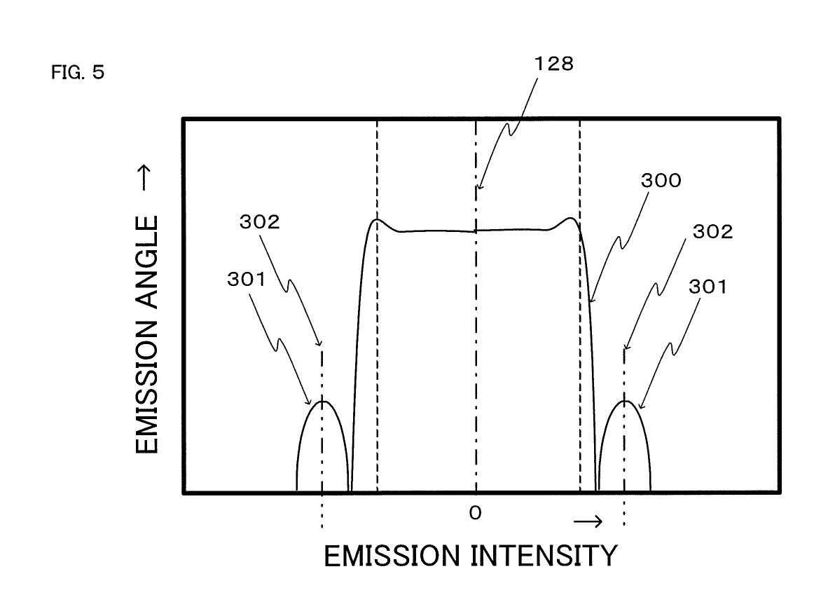

FIG. 5 is a diagram showing the relation between an emission angle and emission intensity of the optical module 100 of the first embodiment. A dash-dotted line in FIG. 5 indicates a substantially center position 128 of the resin lens 122, and also indicates the center of the optical intensity distribution of the main beam. Also, each of dash-dot-dotted lines 302 in FIG. 5 indicates the center of the optical intensity distribution of each of the sub-beams.

As shown in FIG. 5, the main beam, which is emitted from the first focusing surface 125 to the optical irradiation region 127 which is in front of the module 100, has a shallow emission angle. Therefore, in a long distance communication, the main beam contributes to the communication. Because of this, preferably, the emission intensity 300 (a large peak in the middle in FIG. 5) of the main beam is strengthened to a certain extent at the time of designing so as to allow the communication even in a relatively long distance. On the other hand, the sub-beams, which are emitted from the second focusing surface 126 to the optical irradiation region 129 near the main beam, have steep emission angles, and contribute to the communication when the position of the optical receiver 230 of the optical module 200 deviates from the optical irradiation region 127 which is in front of the module 100, and the communication is performed in a short distance. Thus, the radiant intensities 301 (small peaks on sides in FIG. 5) of the sub-beams do not need to be unduly strengthened, and may be weaker than that of the main beam.

If, in FIG. 2 and FIG. 4, the positions of the optical transmitter and the optical receiver of the optical module 200 are switched with each other and the optical receiver of the optical module 200 is present in front of the optical transmitter of the optical module 100, the communication is performed by using the main beam regardless of the distance.

<Verification of the Effect>

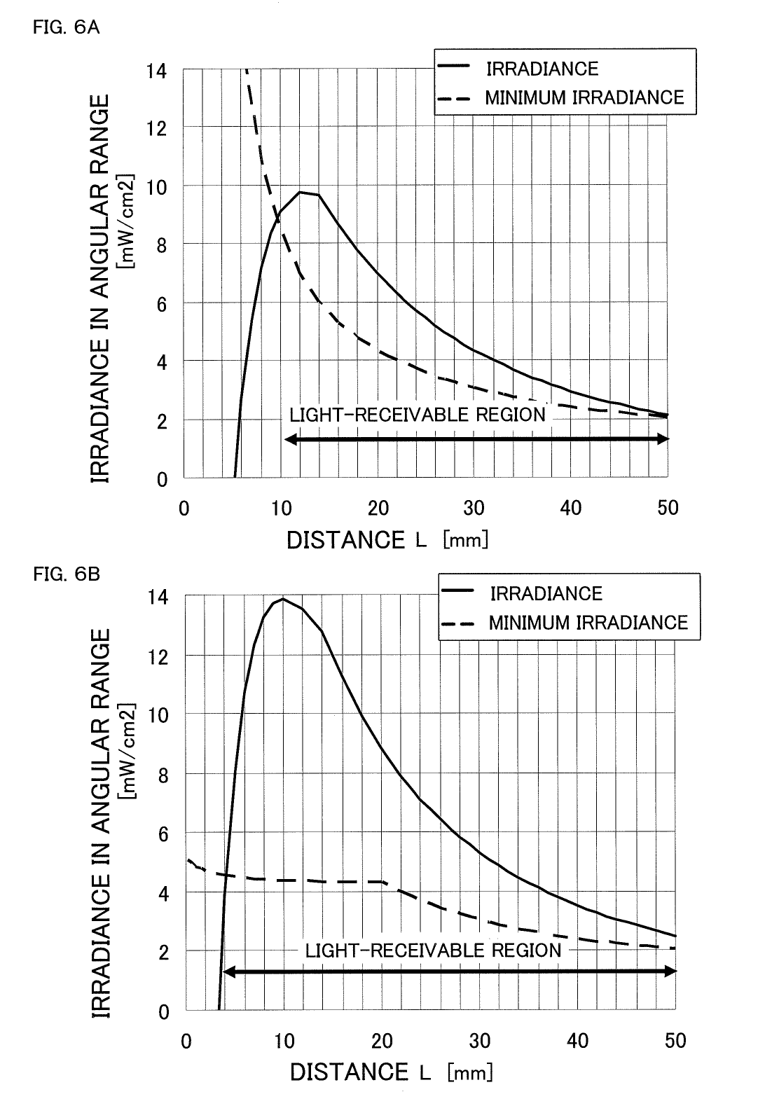

FIG. 6A and FIG. 6B are diagrams each showing relation between the distance between the optical modules, the receiving irradiance, and the minimum irradiance, obtained by simulation in the optical wireless system 10 of the first embodiment.

FIG. 6A and FIG. 6B both show how the receiving irradiance and the minimum irradiance change if the distance between the mobile devices is changed in the state where the respective optical transmitters face each other and the respective optical receivers face each other.

As for the conditions of the simulation in FIG. 6A, the conventional optical wireless system that does not have the second focusing surfaces 126 and 235 is used, the diameter of the lens is 5 mm, an orientation angle of the optical transmitter for transmission is ±10°, and an allowable angle of the optical receiver for reception is ±10°.

As for the conditions of the simulation in FIG. 6B, the optical wireless system 10 of the first embodiment, which has the second focusing surfaces 126 and 235, is used, the optical axis caused by the second focusing surface 126 is 30°, and other conditions are the same as those of FIG. 6A.

According to FIG. 6A, a receivable region, in which the receiving irradiance exceeds the minimum irradiance in the conventional optical wireless system is, 9.8 mm to 50.0 mm.

On the other hand, according to FIG. 6B, the receivable region, in which the receiving irradiance exceeds the minimum irradiance in the optical wireless system 10 of the first embodiment, is 4.1 mm to over 50.0 mm.

The irradiance in the short distance is increased in FIG. 6B than in FIG. 6A. This seems to be caused by the sub-beam emitted from the second focusing surface 126.

Moreover, the minimum irradiance is increased as the distance between the mobile devices is reduced in FIG. 6A. This seems to be caused by that, if the distance between the mobile devices is reduced in the state where the respective optical transmitters face each other and the respective optical receivers face each other, an irradiation angle of the beam received by the optical receiver is increased.

The photodetector generally has a tendency that the smaller the irradiation angle is, the higher the coupling efficiency becomes. Thus, in a conventional configuration in which no countermeasure is taken in the optical-receiving part, if the distance between the mobile devices is reduced, the coupling efficiency exceedingly decreases, causing the minimum irradiance to precipitously increase on contrary.

On the other hand, even though the distance between the mobile devices is reduced, the minimum irradiance is not increased so much in FIG. 6B. This seems to be caused by that the optical wireless system 10 of the first embodiment has the second focusing surface 235 in the optical receiver, and therefore optical, which is irradiated at an angle greater than an intended allowable angle (e.g., ±10°) for the reception, can be focused on the photodetector.

Note that the characteristic of variation in the coupling efficiency according to the irradiation angle of the photodetector depends on a photodetector. Since the simulations described above do not use actually measured values, the effects described above are merely examples of predictions.

As described above, according to the optical wireless system 10 of the first embodiment, in the state where the respective optical transmitters face each other and the respective optical receivers face each other, the receivable region can be extended broader than the conventional, and the excellent communication can be performed, particularly, in a short distance. Therefore, when communication is performed with the transmission optical beam being narrowly stopped down by using the lens for achieving high-speed communication, or the like, even if the optical modules become closer to each other, the communication can be performed regardless of the positional relationship between these optical modules. Additionally, the optical wireless system 10 can be reduced in scale, and necessity of the optical axis adjustment can be eliminated.

<Determining the Irradiation Angle of the Sub-Beam>

The following describes a method of determining a maximum value and a minimum value of the irradiation angle θ of the sub-beam.

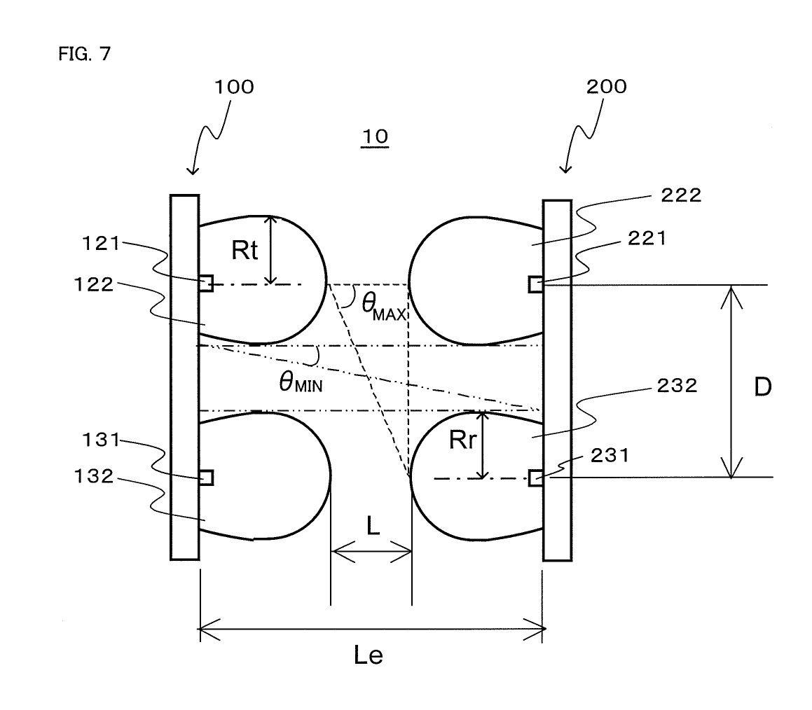

FIG. 7 is a diagram showing an outline of the optical wireless system 10 when the short-distance communication is performed. The same reference numerals are given to the components that are similar to those in FIG. 2, and the description thereof is omitted.

In FIG. 7, even if the sub-beam is emitted from any direction, the irradiation angle of the optical axis of the sub-beam does not exceed, at least, an angle: θ MAX which is formed between the optical axis of the main beam and a line which joins vertices of the lenses between transmission and reception. Thus, according to FIG. 7, the value of the maximum irradiation angle of the optical axis of the sub-beam is represented by the following formula:

θ MAX=tan⁻¹(D/L) (1)

where “D” denotes a distance between the light source 221 and the photodetector 231 in a direction parallel to the mounting substrate 210, and “L” denotes a distance, of a direction component perpendicular to the mounting substrate 210, between the end of the resin lens 122 and the end of the resin lens 232 in their closest approach where the normal communication should be performed.

On the other hand, the optical axis of the sub-beam, when the irradiation angle becomes smallest, is represented by a line that joins intersection points where the side surfaces of the lenses between the transmission and the reception meet the respective mounting substrates (an intersection point, on a side closer to the photodetector 231, at which the side surface of the resin lens 122 meets the mounting substrate 110, and an intersection point, on a side closer to the light source 121, at which the side surface of the resin lens 232 meets the mounting substrate 210). If the sub-beam is emitted at an emission angle narrower than an angle: θ MIN, which is formed between this line and the optical axis of the main beam, the optical is not irradiated on a facing receiver. Thus, according to FIG. 7, the minimum irradiation angle of the optical axis of the sub-beam is represented by the following formula:

θ MIN=tan⁻¹{(D−Rt−Rr)/Le} (2)

where “D” denotes the distance between the light source 221 and the photodetector 231 in the direction parallel to the mounting substrate 210, “Rt” denotes a lens radius of the resin lens 122, “Rr” denotes a lens radius of the resin lens 232, and “Le” denotes the distance, of the direction component perpendicular to the mounting substrate 210, between the light source 121 and the photodetector 231 in their closest approach where the communication should be performed. Moreover, “D−(Rt+Rr)” denotes a distance, of a direction component parallel to the mounting substrate 210, between the resin lens 122 and the resin lens 232.

According to the formulas (1) and (2), the irradiation angle θ of the sub-beam satisfies the following formula.

tan⁻¹{(D−Rt−Rr)/Le}≦θ≦tan⁻¹(D/L) (3)

When the second focusing surface 126 of the optical transmitter 120 is designed so as to satisfy the formula (3), the sub-beam focused by the second focusing surface 126 can be efficiently irradiated on the optical receiver 230 even if the optical modules become close to each other and thereby the respective optical transmitters face each other, and the respective optical receivers face each other.

### Embodiment 2

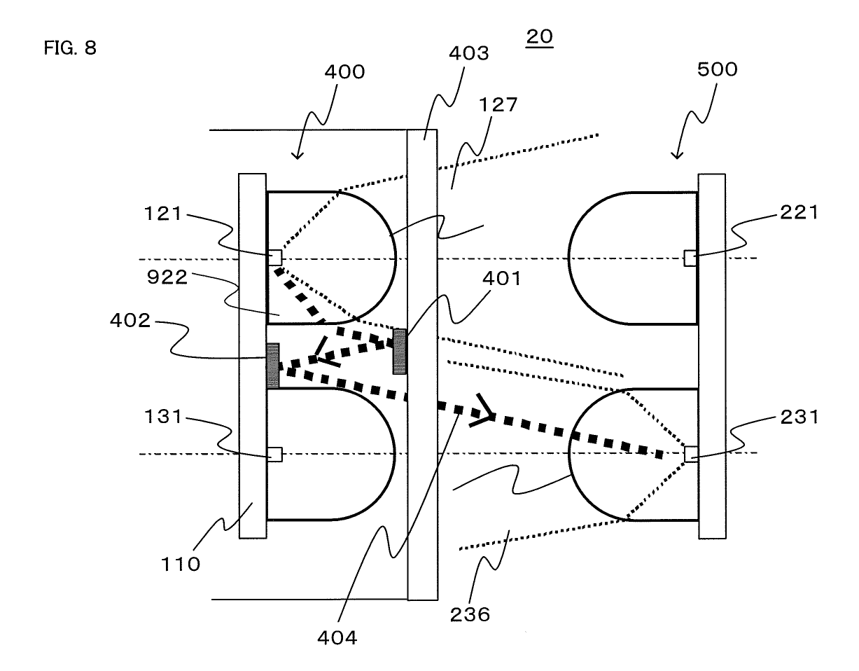

FIG. 8 is a diagram showing an outline of an optical wireless system 20 in a second embodiment.

In FIG. 8, an optical module 400 and an optical module 500 are a unit for the short-range wireless communication in which each module emits an optical beam to space to perform data communication.

In FIG. 8, the optical module 400 and the optical module 500 are close to each other with a distance of about 4 mm to 5 mm therebetween, and thereby the respective optical transmitters face each other and the respective optical receivers face each other. The same reference numerals are given to the components that are similar to those in FIG. 2, FIG. 3A and FIG. 3B, and the description thereof is omitted.

In the second embodiment, a first reflector 401 is disposed, between the optical module 400 and the optical module 500, facing the mounting substrate 110. A second reflector 402 is disposed on the mounting substrate 110 between the optical module 400 and the optical module 500.

The first reflector 401 reflects a portion of a beam emitted from the resin lens 922.

The second reflector 402 further reflects the portion of the beam having been reflected by the first reflector 401 to reflect the portion of the beam reflected by the first reflector 401 as a sub-beam 404. The remaining beam, which has not been reflected by the first reflector 401, becomes a main beam.

When infrared communication is performed, usually, a visible light cut filter, although not requisite, which removes visible light, is often included to alleviate the adverse effect caused by the visible light. If the visible light cut filter is included, the first reflector 401 can be disposed on a part of the visible light cut filter 403 as shown in FIG. 8. In this case, it is preferred that the first reflector 401 and a receiving region of the optical receiver overlap with each other as little as possible. Note that, the first reflector 401 can be produced, for example, by evaporating a metal, such as aluminum, on a necessary part of the visible light cut filter 403. Likewise, the second reflector 402 can be produced, for example, by evaporating a metal, such as aluminum, on a necessary part of the mounting substrate 110.

As described above, the portion of the beam emitted from the resin lens 922 is once reflected by the first reflector 401 so as to be directed to a direction opposing to the optical module 500, and then reflected again by the second reflector 402 in a direction toward the optical module 500, thereby causing the portion of the beam to move in parallel.

Consequently, when the optical modules become close to each other and thereby the respective optical transmitters face each other and the respective optical receivers face each other, the transmission optical beam, which originally does not reach the photodetector, can be transmitted to the photodetector.

Note that, although the portion of the beam emitted from the first focusing surface 125 is reflected so as to be reflected as a sub-beam here, the sub-beam, shown in the first embodiment, which is emitted from the second focusing surface 126, may be caused to be reflected.

In order to cause the sub-beam emitted from the second focusing surface 126 to be reflected, preferably, the first reflector 401 is disposed such that the first reflector 401 and the optical irradiation region 127 caused by the first focusing surface 125 overlap with each other as little as possible. In this case, the irradiation angle is increased. Therefore, this case is more preferable when a space between the optical transmitter and the optical receiver is relatively great.

Moreover, in order to cause the portion of the beam emitted from the first focusing surface 125 to be reflected, preferably, the first reflector 401 is disposed such that the first reflector 401 and a portion of the optical irradiation region 127 caused by the first focusing surface 125 overlap with each other, and the area of the first reflector 401 is defined so as to achieve irradiance which allows reception in a distance by which the optical irradiation regions 127 and 236 do not overlap with each other in the state where the respective optical transmitters face each other and the respective optical receivers face each other. In this case, the irradiation angle is not increased so much. Therefore, this case is more preferable when a space between the optical transmitter and the optical receiver is relatively small. Furthermore, the photodetector generally has a tendency to have higher coupling efficiency for a smaller irradiation angle. Therefore, when the portion of the beam is caused to be reflected, the coupling efficiency in the optical module 500 is likely to increase. Because of this, the sub-beam can favorably be received under a difficult situation in which the optical modules are close to each other, the respective optical transmitters are facing each other and the respective optical receivers are facing each other, even by the optical receiver of the optical module 500 that has a configuration similar to that of the conventional in which no countermeasure is taken.

### INDUSTRIAL APPLICABILITY

An optical module and an optical wireless system of the present invention are applicable to various electronic devices, such as mobile phones, PCs, and printers, and are highly useful because a receivable region can be extended broader than the conventional under a difficult situation, for example, where optical modules are close to each other and thereby the respective optical transmitters face each other and the respective optical receivers face each other. Excellent communication can be performed, particularly, in a short distance.

What is claimed is:

1. An optical module for performing short-range wireless communication with an other optical module, comprising:
an optical transmitter for emitting a transmission optical beam to the other optical module; and
an optical receiver for receiving a reception optical beam from the other optical module, wherein
the optical transmitter includes:
a light source for emitting an optical signal based on information to be transmitted; and
a lens for the light source, for focusing the optical signal emitted by the light source so that the focused optical signal is emitted, wherein
the transmission optical beam includes:
a main beam having a center of the intensity distribution at a substantially center position of the lens for the light source; and
a sub-beam having a center of the intensity distribution outside of a predetermined region from the center of the intensity distribution of the main beam.

2. The optical module according to claim 1, wherein
the light source emits optical signals from a top surface and side surfaces thereof,
a principal component of the main beam is the optical signal emitted from the top surface of the light source, and focused by the lens for the light source, and
a principal component of the sub-beam is the optical signals emitted from the side surfaces of the light source, and focused by the lens for the light source.

3. The optical module according to claim 1, wherein
the lens for the light source includes:
a main focusing surface on which a center portion of the optical signal emitted by the light source is focused so that the main beam is emitted; and
a sub focusing surface on which portions, except for the center portion, of the optical signal emitted by the light source are focused so that the sub-beam is emitted.

4. The optical module according to claim 1, wherein
an irradiation angle θ of the sub-beam satisfies the following conditions:
tan⁻¹ {(D−Rt−Rr)/Le}≦θ≦tan⁻¹(D/L)
where,
D is a distance between an optical transmitter included in the other optical module and an optical receiver included in the other optical module, in a direction parallel to a mounting substrate of the other optical module on which the optical transmitter and the optical receiver are mounted,
Rt is a radius of the lens for the light source,
Rr is a radius of a lens for a photodetector, included in the optical receiver provided in the other optical module,
L is a distance, of a direction component perpendicular to the mounting substrate of the other optical module, between an end of the lens for the light source and an end of the lens for the light source included in the optical transmitter provided in the other optical module in their closest approach where normal communication should be performed, and
Le is a distance, of the direction component perpendicular to the mounting substrate of the other optical module, between the light source and a light source included in the optical transmitter provided in the other optical module in their closest approach where the normal communication should be performed.

5. The optical module according to claim 1, wherein
the optical module further includes:
a mounting substrate on which the light source and a photodetector are mounted;
a first reflector, facing the mounting substrate between the light source and the photodetector, for reflecting a portion of the beam emitted from the lens for the light source; and
a second reflector, disposed between the light source and the photodetector on the mounting substrate, for further reflecting the beam having been reflected by the first reflector to reflect the beam reflected by the first reflector as a sub-beam.

6. The optical module according to claim 1, wherein
the optical module further includes:
a mounting substrate on which the light source and a photodetector are mounted;
a first reflector, facing the mounting substrate, for reflecting the sub-beam; and
a second reflector, disposed between the light source and the photodetector on the mounting substrate, for further reflecting the sub-beam reflected by the first reflector.

7. The optical module according to claim 1, wherein
the main beam has a predetermined effective region which has the center of the optical intensity distribution at the substantially center position of the lens for the light source, and
the sub-beam has the center of the intensity distribution outside the predetermined effective region.

8. The module according to claim 1, wherein
the predetermined effective region is a region, determined by a standard relating to short-range wireless communication, in which a beam output, which is at a level greater than specified, needs to be maintained.

9. An optical wireless system for performing short-range wireless communication between a first light module and a second optical module, wherein
the first optical module includes:
a first optical transmitter for emitting a first transmission optical beam to the second optical module; and
a first optical receiver for receiving a reception optical beam from the second optical module,
the first optical transmitter includes:
a first light source for emitting a optical signal based on information to be transmitted; and
a first lens for the first light source for focusing the optical signal emitted by the first light source so that the focused signal is emitted,
the first transmission optical beam includes:
a first main beam having a center of the intensity distribution at a substantially center position of the first lens for the first light source; and
a first sub-beam having intensity distributions outside a predetermined region from the center of the intensity distribution of the first main beam,
the second optical module includes:
a second optical transmitter for emitting a second transmission optical beam to the first optical module; and
a second optical receiver for receiving a reception optical beam from the first optical module,
the second optical transmitter includes:
a second light source for emitting an optical signal based on information to be transmitted; and
a second lens for the second light source for focusing the optical signal emitted by the second light source so that the focused optical signal is emitted,
the second transmission optical beam includes:
a second main beam having a center of the intensity distribution at a substantially center position of the second lens for the second light source; and
a second sub-beam having a center of the intensity distribution outside a predetermined region from the center of the intensity distribution of the second main beam.
